(19) United States
(12) Patent Application Publication
(10) Pub. No.: US 2023/0092802 A1
(43) Pub. Date: Mar. 23, 2023

(54) BITUMINOUS COMPOSITION CONTAINING AN EPOXIDIZED OIL

(71) Applicant: Arkema France, Colombes (FR)

(72) Inventors: Rabi Inoubli, Pierre-Benite Cedex (FR); Gilles Barreto, Pierre-Benite Cedex (FR); Justine Cantot, Pierre-Benite Cedex (FR)

(73) Assignee: Arkema France, Colombes (FR)

(21) Appl. No.: 17/798,764

(22) PCT Filed: Feb. 5, 2021
(86) PCT No.: PCT/FR2021/050219

§ 371 Date: Aug. 10, 2022

(30) Foreign Application Priority Data
Feb. 14, 2020 (FR) 2001495

(51) Int. Cl. C08L 95/00; C08L 91/00; C08L 71/02

(52) U.S. Cl. CPC C08L 95/00; C08L 91/00; C08L 71/02; C08L 2555/80

(57) ABSTRACT

A subject of the present invention is a composition comprising:
at least one recycled bituminous product,
at least one epoxidized oil, and
at least one bitumen additive.

The invention also relates to the use thereof for the preparation of a mix. Another subject of the invention is a mix comprising the composition according to the invention.

### CROSS-REFERENCE TO RELATED APPLICATIONS

This application is a 371 filing of International Application No. PCT/FR2021/050219, filed Feb. 5, 2021, which claims priority to French Application No. 2001495 filed Feb. 14, 2020, the disclosures of these applications being incorporated herein by reference in their entireties for all purposes.

### FIELD OF THE INVENTION

The present invention relates to a bituminous composition comprising at least one recycled bituminous product, at least one epoxidized oil, and at least one bitumen additive. The invention also relates to the process for preparing same and the use thereof for the preparation of a mix. Another subject of the invention is a mix comprising the composition according to the invention, and also a drivable surface produced from said mix. The invention also relates to a composition comprising at least one recycled bituminous product and at least one epoxidized oil.

### BACKGROUND OF THE INVENTION

Bitumen (or asphalt) is the heaviest portion recovered during the petroleum distillation process. Due to the diverse origins and processes for distillation of such oils, the resulting bitumen can exhibit a varied range of properties and characteristics. In the present invention, the term “bitumen” denotes not only the product obtained from petroleum by direct distillation or by reduced-pressure distillation of petroleum, but also the products obtained by extraction of pitch and oil sands, the products of oxidation and/or fluxing of such bituminous materials with carbon-based solvents, including paraffins and waxes, and also with solvents derived from plant oils, and also foamed and semi-foamed bitumens, synthetic bitumens using renewable materials such as those described for example in applications FR2853647 A and FR2915204 A, pitches, petroleum resins or indene-coumarone resins mixed with aromatic and/or paraffinic hydrocarbons, mixtures thereof and mixtures of such bituminous materials with acids.

### SUMMARY OF THE INVENTION

The main application of bitumen is the inclusion in mixes, where the bitumen is mixed with mineral aggregates, which can be of various sizes, shapes and chemical natures, said bitumen fulfilling the function of binder in said mineral aggregates. These mixes are particularly used in the construction, repair and maintenance of sidewalks, roads, highways, parking lots or runways and airport service roads, and any other driveable surface.

The mineral aggregates used in the mixes are generally quarry products, and are increasingly often used in combination with aggregates recycled from previously manufactured mixes. Such recycled aggregates are known under the generic name of mix millings or mix aggregates or else RAP (Reclaimed Asphalt Pavement), for example defined in the French standard AFNOR XP P98-135 of December 2001 or in the Asphalt Handbook, MS-4, 7^{th} edition, published by the Asphalt Institute, USA.

However, the issue of recycling is becoming predominant and will even be imposed in the near future by new European regulations. Currently, the renovation of pavements using RAP remains relatively limited for two reasons. First, RAPs are not readily available, although this trend is on the rise. Next, obtaining recycled pavement with the expected mechanical and aging properties is still tricky. It is known to those skilled in the art that incorporating a high content of RAP tends to harden the new mix, thus promoting premature cracking phenomena and reducing the service life of the pavement. The bitumen contained in such recycled bituminous products is generally aged, and therefore harder than normal fresh bitumen for mixes. This is one of the reasons why only a limited amount of recycled bituminous products such as RAPs are generally added to the mixes.

One of the possible causes of the aging of bituminous coatings is thought to be due to an increase in the content of asphaltene. These asphaltenes are thought to be partly responsible for the hardening of the bitumen and its degraded properties. Thus, bitumens comprising recycled bitumen are all the more prone to aging owing to the fact that they comprise already aged bitumen.

These days, there is an economic and environmental interest in incorporating recycled bituminous products (recycled aggregates and/or other components linked to bitumen as described above) in new mixes. Significant savings can be made by reusing the bitumen already present in such recycled bituminous products. Specifically, the binder is generally the most expensive component of the mixes.

Bitumen is not a renewable product. Its extraction and production of bitumen from its initial source (crude oil) have a significant impact on the environment, which impact is reduced by the use of RAP. Furthermore, the constraints on quarries make it problematic to extend existing quarries or to create new quarries in order to increase operations.

Consequently, it is necessary to propose solutions that make it possible to improve the mechanical properties and the aging properties of bitumens comprising recycled bitumen.

The objective of the present invention aims to improve the aging of bitumens comprising recycled bitumen. It is known from document WO2017027096 to use compounds derived from sterols to slow down the aging of bitumens comprising a portion of recycled bitumens.

The inventors have discovered that a particular mixture of additives makes it possible to considerably extend the service life of a bituminous composition based on recycled bitumen.

A subject of the present invention is a bituminous composition comprising:
at least one recycled bituminous product,
at least one epoxidized oil, and
at least one bitumen additive.

The invention also relates to the process for preparing same and the use thereof for the preparation of a mix. Another subject of the invention is a mix comprising the composition according to the invention, and also a drivable surface produced from said mix.

It is specified that the expressions “from . . . to . . . ” and “between . . . and . . . ” used in the present description should be understood as including each of the limits mentioned.

The bituminous composition according to the invention comprises a recycled bituminous product. In the description of the present invention, the term “bituminous product” means bitumens, and also a mixture thereof with organic or mineral fillers, preferably mineral fillers, such as sand, gravel, pebbles, aggregates. For the purposes of the present invention, the term “recycled bituminous product” means any manufactured product comprising bitumen as one of its components, said manufactured product comprising bitumen that has been previously used or scrapped after production. Nonlimiting examples of such recycled bituminous products include mix millings or RAP (Reclaimed Asphalt Pavement) obtained by milling roads or other driveable surfaces, waterproofing membranes, bituminous shingles used for roofing (shingle millings or RAS for reclaimed asphalt shingle), soundproofing panels, production waste, mixtures of two or more of the above elements.

RAPs also include recycled mixes where the mineral aggregates are partially or totally replaced by other common components, such as, by way of limiting examples, organic and inorganic fibers (for example glass, metal or carbon fibers, cellulose, cotton, etc.), polymers, for example polypropylenes, polyesters, poly(vinyl alcohols), polyamides, polyurethanes, polyureas, copolymers of ethylene/vinyl acetate (EVA) and styrene-butadiene-styrene (SBS).

### DETAILED DESCRIPTION OF THE INVENTION

According to a first embodiment, the bituminous composition according to the invention comprises at least one epoxidized oil, at least one bitumen additive and only recycled bitumen. In other words, it does not include any other bituminous products, apart from the recycled bitumen.

The bituminous composition according to the invention can also comprise non-recycled mineral aggregates.

According to a second embodiment of the invention, the composition according to the invention comprises a bitumen which is a mixture of recycled bitumen and non-recycled, i.e. fresh, bitumen. Preferably, the bitumen comprises from 10% to 90% by weight of recycled bitumen, and more preferentially from 20% to 80% by weight, particularly from 30% to 70% by weight, and even more preferably from 40% to 60% by weight, relative to the total weight of the mixture.

The non-recycled bitumens are bitumens from various origins. Mention may first of all be made of bitumens of natural origin, those contained in natural bitumen deposits, natural asphalt deposits, or tar sands.

The non-recycled bitumens are also bitumens originating from the refining of crude oil. The bitumens originate from the atmospheric and/or vacuum distillation of petroleum. These bitumens can optionally be blown, oxidized, visbroken and/or deasphalted. The bitumens may be hard-grade or soft-grade bitumens. The various bitumens obtained by refining processes may be combined together to obtain the best technical compromise.

The non-recycled bitumens may also be bitumens fluxed by addition of volatile solvents, of fluxes of petroleum origin, of carbochemical fluxes and/or of fluxes of plant origin.

Polymer-modified bitumens may also be used. As polymer, mention may for example, and by way of nonlimiting indication, be made of thermoplastic elastomers such as linear or star-branched styrene/butadiene (SBR, SBS) or styrene/isoprene (SIS) random or block copolymers, which are optionally crosslinked, ethylene/vinyl acetate copolymers, olefinic homopolymers and copolymers of ethylene (or propylene or butylene), polyisobutylenes, polybutadienes, polyisoprenes, poly(vinyl chloride), crumb rubbers or else any polymer used to modify bitumens, and blends thereof. An amount of polymer of from 2% to 10% by weight relative to the weight of bitumen is generally used.

Synthetic bitumens, also known as clear, pigmentable or colorable bitumens, may also be used. These bitumens contain little or no asphaltenes and can consequently be colored. These synthetic bitumens are based on petroleum resin and/or on indene-coumarone resin and on lubricating oil, as described for example in patent EP179510.

Advantageously, the non-recycled bitumen is a bitumen with a penetrability, measured according to the standard NF EN 1426 of June 2007, ranging from 10 to 300, preferentially from 20 to 220, more preferentially from 70 to 220.

Preferably, the non-recycled bitumen present in the bituminous composition according to the invention is chosen from unmodified bitumens from the refining of crude oil.

The bituminous composition according to the invention comprising non-recycled bitumen can also comprise non-recycled mineral aggregates.

The bitumen, whether it is recycled or non-recycled, can be in anhydrous form, in the form of an emulsion or else in the form of a foam.

The bituminous composition according to the invention comprises at least one epoxidized oil. For the purposes of the present invention, the term “epoxidized oil” means an oil comprising at least one epoxide function.

Preferably, the epoxidized oil is chosen from epoxidized fatty acid monoesters, epoxidized fatty acid diesters, epoxidized fatty acid triesters and a mixture thereof, preferably epoxidized fatty acid diesters, epoxidized fatty acid triesters and a mixture thereof, more particularly, epoxidized fatty acid triesters. For the purposes of the present invention, the term “fatty acid” means preferably acids comprising from 8 to 26 carbon atoms. The epoxidized oils according to the invention are generally obtained by partial or total epoxidation of monounsaturated or polyunsaturated oils. The epoxidized oils according to the invention can be monoepoxidized or polyepoxidized, saturated or unsaturated. Preferably, the epoxidized oils according to the invention are a mixture of epoxidized fatty acid monoesters, epoxidized fatty acid diesters and epoxidized fatty acid triesters, which are monoepoxidized or polyepoxidized, saturated or unsaturated. More particularly, the epoxidized oils according to the invention are monoepoxidized or polyepoxidized, saturated or unsaturated fatty acid triesters.

The epoxidized oils according to the invention are chosen from epoxidized oils derived from myristoleic acid, sapienic acid, elaic acid, vaccenic acid, linoleic acid, erucic acid, linolenic acid, linolelaidic acid, oleic acid, elaidic acid, arachidonic acid, palmitoleic acid. Preferably, the epoxidized oils are derived from linoleic acid, linolenic acid, oleic acid, elaidic acid, erucic acid, palmitoleic acid. These oils may contain diglycerides or triglycerides. In this case, the alcohol functions of the glycerol have reacted with the acid function of at least one monounsaturated or polyunsaturated fatty acid. The glycerol may have reacted with one unsaturated fatty acid and two saturated fatty acids, such as stearic acid, palmitic acid or lauric acid, with two unsaturated fatty acids and one saturated fatty acid, or else with three unsaturated fatty acids. The epoxidized oils can be obtained from natural plant or animal oils. The epoxidized oils according to the invention can be obtained from avocado oil, coconut oil, castor oil, corn oil, cottonseed oil, linseed oil, grapeseed oil, hemp oil, jojoba oil, mustard oil, dehydrated castor oil, palm oil, rapeseed oil, safflower oil, soybean oil, sunflower oil, tall oil, olive oil, linoleic oil, peanut oil and mixtures thereof. It should be understood that although these materials are most conveniently derived from the examples of natural sources listed above, these structures synthesized by any other means are also envisioned within the context of the invention.

Preferably, the epoxidized oil present in the bituminous composition according to the invention is epoxidized soybean oil, epoxidized linseed oil and a mixture thereof.

For example, a range of epoxidized oils is available under the trade name Vikoflex® sold by Arkema France.

The bituminous composition according to the invention may comprise from 0.01% to 10%, preferably from 0.05% to 10% by weight of epoxidized oil relative to the total weight of the composition, preferably from 0.05% to 8% by weight, and more particularly from 0.05% to 5% by weight.

The bitumen additive included in the bituminous composition according to the invention is chosen from formula (1) and the compounds of formula (2) below:

[A-O—B-]_{d}Z (1)

(E)ⱼ-Y (2)

wherein:
A is chosen from a a hydrogen atom, a group G, a group

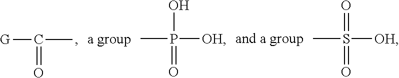

where G represents a linear or branched, saturated or unsaturated C₁-C₃₀ hydrocarbon-based chain optionally comprising at least one aromatic ring, and optionally substituted with at least one phosphate group, preferentially a single phosphate group,
B represents a divalent group containing at least one repeating unit of alkylene oxide type,
d is equal to 1 or two 2, and
Z is chosen from a hydrogen atom, a radical of formula Z1 and a radical of formula Z2:

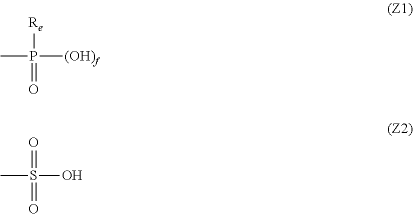

where R represents a hydrogen atom or a linear or branched C₁-C₆ alkyl group, f is equal to 0, 1 or 2, e is equal to 0 or to 1, and d+e+f is equal to 3,
a group G, and a group

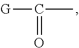

where G is as defined above,
it being understood that when d is equal to 1, then Z is chosen from a hydrogen atom, a radical of formula Z1, a radical of formula Z2, a group G, and a group

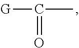

where G is as defined above,
and that when d is equal to 2, then Z represents Z1, e is equal to zero (0) and P is bonded to two groups [A-O—B-] which may be identical or different, preferentially identical, as defined above,
E is chosen from the groups G,

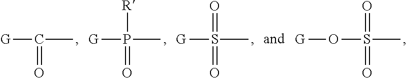

where G is as defined above,
j is equal to 1 or 2,
R′ is chosen from the group consisting of HO—, Q-O— and Q, where Q represents a linear or branched C₁-C₆ alkyl radical,
Y represents a group chosen from —O-T, —S-T, —N(H)₍₂₋ⱼ₎-T and -NT₁T₂, and preferentially Y represents —N(H)₍₂₋ⱼ₎-T or -NT₁T₂, provided that Y does not represent —S-T, when E is bonded to Y via a sulfur atom,
T represents a hydrogen atom or a group which is linear, branched or cyclic or contains a cyclic group and which comprises carbon and hydrogen atoms, and optionally one or more heteroatoms chosen from nitrogen, oxygen, sulfur and phosphorus, and
the radicals T₁ and T₂ are identical or different and have the same value as T defined above, or form together and with the nitrogen atom to which they are bonded a saturated, partially saturated or unsaturated heterocycle optionally also comprising one or more heteroatoms chosen from nitrogen, oxygen, sulfur and phosphorus.

In the context of the present invention, the term “alkylene oxide” preferentially means butylene oxide (BO), propylene oxide (PO) or ethylene oxide (EO), it being understood that a “divalent group containing at least one repeating unit of alkylene oxide type” is a divalent group which may include one or more BO and/or PO and/or EO repeating units.

More preferentially, B represents a divalent group comprising repeating units of propylene oxide (PO) and/or ethylene oxide (EO) type, generally distributed randomly or in blocks, preferentially in blocks. Even more preferentially, B represents a block or random copolymer of ethylene oxide and propylene oxide comprising between 4 and 500 repeating units, with a mass ratio (ethylene oxide/copolymer) of between 1% and 70%.

Preferably, A denotes a hydrogen atom, B denotes a divalent group comprising repeating units of butylene oxide (BO), propylene oxide (PO) and/or ethylene oxide (EO) type, generally distributed randomly or in blocks, preferentially in blocks, d is equal to 1 and Z denotes a hydrogen atom.

Even more preferentially, A denotes a hydrogen atom, B represents a block, alternating or random copolymer comprising one or more ethylene oxide units and/or one or more propylene oxide units, and/or one or more butylene oxide units, and comprising a total of between 4 and 500 repeating units, d is equal to 1 and Z denotes a hydrogen atom.

Even more preferentially, A denotes a hydrogen atom, B represents a block, alternating or random copolymer comprising one or more ethylene oxide units and one or more propylene oxide units, and comprising a total of between 4 and 500 repeating units, d is equal to 1 and Z denotes a hydrogen atom.

These products are sold by Arkema France under the trade name Ensoline®.

Preferentially, Z represents Z1, B includes and preferentially represents —(CH₂CH(CH₃)O)_{g}—(CH₂CH₂O)ₕ— distributed randomly or in blocks, where g is between 0 and 10 and h is between 0 and 80, the sum g+h not being equal to 0, preferentially between 1 and 60, and more preferentially between 2 and 40. In this case, the additive of formula (1) can be represented by formula A1ₒ:

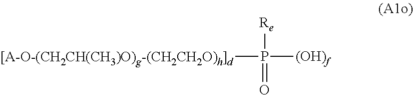

wherein A, R, d, e, f, g and h are as described above.

Alternatively, when the PO and/or EO repeating units (distributed randomly or in blocks) are linked to Z by a hydrocarbon-based chain, and when Z represents Z1, the additive of formula (1) can be described by formula A1_{C} below:

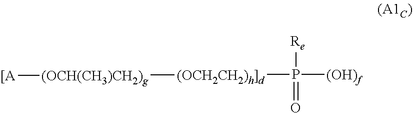

wherein A, R, d, e, f, g and h are as described above.

In one preferred embodiment, in the additive of general formula (1), g represents 0, when A comprises at least 10 carbon atoms. Still in a preferred embodiment, in the additive of general formula (1), g is preferably between 1 and 80, preferentially between 2 and 60, when A contains less than 10 carbon atoms.

According to yet another embodiment of the present invention, the groups A and Z represent a hydrogen atom and B represents a block or random copolymer of ethylene oxide and propylene oxide comprising between 4 and 500 repeating units, with a mass ratio (ethylene oxide/copolymer) of between 1% and 70%. Preferentially, B represents a triblock copolymer, the propylene oxide constituting the middle block. In this case, the additive of formula (1) can be represented by formula (A1H) below:

H—O—(CH₂CH₂—O)ₓ—(CH₂—CH(CH₃)O)_{y}—(CH₂CH₂—O)_{z}—H (A1_{H})

wherein x, y and z represent the number of repeating units of each type, the sum x+y+z being between 4 and 500, and the ratio 44(x+z)/(44(x+z)+57y) being between 0.1 and 0.7.

According to yet another aspect of the present invention, the group A represents a hydrogen atom, d is equal to 1, Z represents a group G or a group

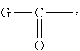

where G represents a linear or branched, saturated or unsaturated C₁-C₃₀ hydrocarbon-based chain, optionally comprising at least one aromatic ring, and B represents a divalent group comprising at least one propylene oxide (PO) repeating unit and/or at least one ethylene oxide (EO) repeating unit.

According to yet another aspect of the present invention, the additive corresponds to formula (1) defined above, wherein d is equal to 1, Z represents Z1, B is as defined above, and A represents a group

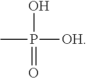

According to another aspect of the present invention, the additive corresponds to formula (1), wherein d is equal to 2, in which case said formula (1) can be represented by formula (A1₂):

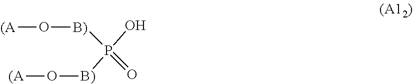

wherein the two groups (A-O—B—) are identical or different, preferentially identical, the groups A and B being as defined above.

In another preferred embodiment, the additive of formula (1) does not contain more than 3 phosphorus atoms.

All the additives of formula (1) as defined above, including the additives of formulae A1ₒ, A1_{C}, A1_{H} and A1₂, are known compounds and can be easily obtained from known suppliers, or, alternatively, can be easily synthesized according to procedures available in patents, in the non-patent literature, in scientific publications, or in Chemical Abstracts.

Examples of additives of formula (1) for use in the context of the present invention can be phosphoric acid esters, such as for example those sold by Lakeland Chemical under the generic name Lakeland.

In one preferred embodiment, the groups T or T₁ and T₂ represent a group containing a polyalkylamine or a group containing an imidazolidone, imidazolidinone or imidazoline group. Even more preferentially, the group containing a polyalkylamine is a group derived from one of the following groups: dimethylaminopropylamine, N-aminoethylpiperazine, diethylenetriamine, triethylenetetramine, tetraethylenepentamine, pentaethylenehexamine (PEHA), and higher homologs, such as for example higher homologs known under the generic name of “Higher Ethylene PolyAmine” in English, better known under the acronym HEPA, and others.

In another preferred embodiment, the groups T or T₁ and T₂ represent a group containing a group containing an imidazolidone group derived from one of the following groups: 1-(2-aminoethyl)imidazolidin-2-one (UDETA), 1-(2-[(2-aminoethyl)amino]ethyl)imidazolidone (UTETA), 1-(2-{2-[(2-aminoethylamino]ethyl}amino)ethyl]imidazolidone (UTEPA), 11-mercapto-N-(2-(2-oxoimidazolidin-1-yl)ethyl)undecanamide, 1-(2-hydroxyethyl)imidazolidin-2-one (HEIO), N-(6-aminohexyl)-N′-(6-methyl-4-oxo-1,4-dihydropyrimidin-2-yl)urea (UPy), 3-amino-1,2,4-triazole (3-ATA), 4-amino-1,2,4-triazole (4-ATA), etc. Most preferentially, T is derived from UDETA and is a preferred derivative representing T.

According to another preferred embodiment of the invention, the additive is of formula (2), wherein the group E represents a group G or a group

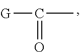

and preferably E represents a group G, where G represents a linear or branched, preferentially linear, saturated or partially unsaturated, preferably partially unsaturated, C₁₄-C₂₂ hydrocarbon-based chain, j is equal to 1 and Y is a polyethyleneamine.

In this case, the additive of formula (2) can be represented by formula E1_{A}:

G-NH—((CH₂-)ₘ—NH)ₖ—H (E1_{A}),

wherein m ranges from 2 to 6 and k ranges from 1 to 20, preferably 1 to 15, more preferably from 1 to 10, even better from 1 to 5,
preferably m is 2, 3 or 4, more particularly m is 2 or 3.

In another preferred embodiment, the additive is represented by formula (2), wherein E represents a group

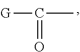

where G represents a linear or branched, preferentially linear, saturated or partially unsaturated, preferably partially unsaturated, C₁₄-C₂₂ hydrocarbon-based chain, j is equal to 1 and Y represents a polyethyleneamine. In this case, the additive of formula (2) can be represented by formula E1_{B}:

G-CO—NH—((CH₂—)ₘ—NH)ₖ—H (E1_{B}),

wherein G, m and k are as defined above.

Examples of additives of formula E1B for use in the context of the present invention can be easily obtained from Arkema France under the generic brand Cecabase®.

Examples of additives of formula (E1_{A}) and of formula (E1_{B}) for the use according to the present invention are available for example from Arkema France in the Polyram® range.

In another additional preferred embodiment, the additive is represented by formula (2), wherein E represents a group

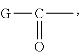

where G represents a linear saturated or partially unsaturated, preferentially partially unsaturated, C₁₄-C₂₂ hydrocarbon-based chain, j is equal to 1 and Y represents a radical derived from the following: 1-(2-aminoethyl)imidazolidin-2-one (UDETA), 1-(2-hydroxyethyl)imidazolidin-2-one (HEIO) or 1-(2-mercaptoethyl)imidazolidin-2-one. In these cases, the additives of formula (2) can be respectively represented by formulae E1_{C}, E1_{D} and E1_{E}:

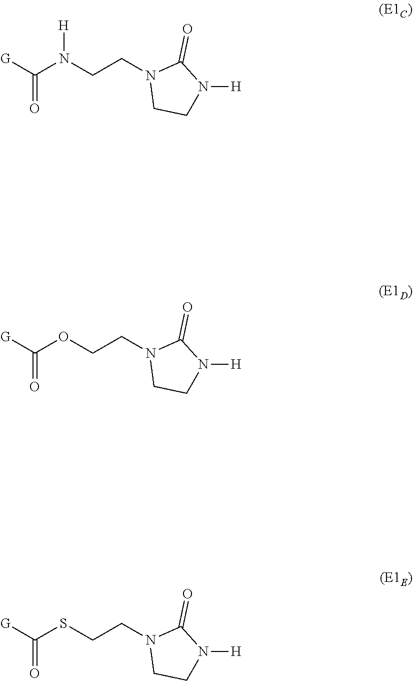

Some of the additives defined above of formula (2), including those of formula E1_{A}, E1_{B}, E1_{C}, E1_{D}, E1_{E}, are known compounds, being for example described in application WO2006016041, or else can be easily obtained from known suppliers, or, alternatively, are easily synthesized by following known procedures, available in patents or the non-patent literature, in scientific publications, or in Chemical Abstracts.

In another embodiment of the present invention, the additives of formula (2) defined above can be modified by following general methods known to those skilled in the art, such as for example and in a non-limiting way, by reaction with alkylene oxides, for example EO (ethylene oxides) and/or PO (propylene oxides) and/or BO (butylene oxides); or by ionization with an inorganic or organic acid, such as hydrochloric acid, phosphoric acid or acetic acid.

Examples of additives modified by reaction with alkylene oxides for use in the context of the present invention are commercially available and can for example be easily obtained from Arkema France under the generic brands Noramox® and Dinoramox®.

The bituminous composition according to the invention comprises a content of between 0.01% and 10% by weight, preferably between 0.05% and 10% by weight, more particularly between 0.05% and 8% by weight, and even more preferentially between 0.05% and 5% by weight relative to the total weight of the composition.

The bituminous composition according to the invention may comprise a weight ratio of the epoxidized oil to the bitumen additive of between from 10/0.5 to 1/5, preferably between 8/1 and 1/2, and more particularly between 5/1 and 1/1.

The oil and the bitumen additive can be added to the bitumen in pure form or else in diluted form, that is to say dissolved, dispersed or emulsified in a liquid. The liquids suitable for dissolving, dispersing or emulsifying the mixture of oil and bitumen additive can be water, organic or inorganic solvents, such as alcohols or plant or mineral oils. Preferably, organic solvents are preferred.

According to another embodiment, the bituminous composition is in the form of an emulsion, comprising water and one or more emulsifiers, optionally one or more organic or mineral acids or organic or mineral bases.

The emulsifiers can be cationic or anionic or nonionic or amphoteric or zwitterionic surfactants.

The aging of the bituminous composition according to the invention is evaluated by measuring an aging index, denoted I, according to the formula below:

$$I = \frac{G * / sin ( δ ) ( vieilli )}{G * / sin ( δ ) ( non vieilli )}$$

wherein
G*/sin(δ) is measured using an AntonPaar MCR 301 rheometer with imposed stress, called a DSR, and a plate/plate geometry device with a diameter of 25 mm and a gap of 1 mm; the measurements are taken by scanning of the temperature from 80 to 40° C. at a frequency of 0.1 Hz and under a deformation of 1%. The reference temperature is 45° C.

This index is defined in the following scientific article: Alex K. Apeagyei; Laboratory evaluation of antioxidants for asphalt binders; Construction and Building Materials 25, (2011), 47-53.

This aging index is a ratio between the values of G*/sin(δ) of the thermally aged system and the unaged system. The higher this ratio, the more the system has undergone aging, which has resulted in an increase in its modulus.

The bituminous composition can also comprise at least one antioxidant. The antioxidant is defined in the publication The Asphalt Handbook (MS-4, 7^{th} edition, 2017). The antioxidant can be a primary antioxidant, also called a radical scavenger; a secondary antioxidant, also called a preventive antioxidant or “hydroperoxide decomposer”; a UV absorber or else a metal deactivator, and mixtures thereof.

Preferably, the antioxidant is chosen from compounds of phenolic structure, phosphite derivatives, hindered amine derivatives and UV stabilizer compounds.

As a phenolic primary antioxidant, compounds with the trade name Irganox 245® or Irganox 1098® or Irganox 1010® from Ciba can be used. As a hindered amine derivative secondary antioxidant, Tinuvin 770® from Ciba can be used. Naugard 445® from Crompton is an amine-derived antioxidant. Tinuvin 312® from Ciba can be used as an antioxidant against UV rays.

The bituminous composition may comprise a content of between 0.01% and 10% by weight of antioxidant relative to the total weight of the composition, preferably between 0.05% and 5% by weight and more particularly between 0.05% and 2.5% by weight relative to the total weight of the composition.

The composition may also comprise one or more other additives commonly used in the field of bitumens and mixes, it being possible for such additives to be chosen from the following:
antistripping agents,
polyphosphoric acid, including all the different qualities and designations existing for polyphosphoric acids, which includes pyrophosphoric acid, triphosphoric and metaphosphoric acids and phosphonic acid,
pyrophosphates and other similar compounds comprising at least one (OH—)P═O group, such as those described in WO2008148974,
polymers generally used to improve the mechanical performance of bitumen and mixes,
waxes, such as Fischer-Tropsch waxes, for example described in U.S. Pat. No. 6,588,974,
fluxes,
antistripping agents,
organic or inorganic acids,
fatty acid esters and functionalized waxes,
resin-like components, such as rosin acids, or modified rosin acids, tall oil pitch, pine tar pitch, pine rosins, tall oil rosins,
asphaltites, for example Gilsonite®,
oils of plant or mineral origin and derivatives thereof,
organic fibers (for example: cellulose, cotton, polypropylene, polyester, polyvinyl alcohol and polyamide fibers) and/or inorganic fibers (for example: glass, metal or carbon fibers),
sterols as defined in document WO2017027096,
and also mixtures of two or more of the above additional additives.

Nonlimiting examples of polymers generally employed to improve the mechanical performance of bitumens and mixtures, i.e. commonly employed in the modification of bitumens, include the following solvents: styrene-butadiene rubbers, styrene/butadiene block copolymers, ethylene/vinyl acetate copolymers, polyethylene and other alpha-polyolefins, such as for example those described in the Asphalt Binder Testing manual, Asphalt Institute (2007).

The invention also relates to a process for preparing the bituminous composition according to the invention. This process includes a step of mixing the epoxidized oil and the bitumen additive with the recycled bitumen at high temperature.

According to a first embodiment, the composition is prepared by mixing the epoxidized oil, the bitumen additive, and optionally other additives present in the composition. The mixture is then added to the recycled bituminous product at high temperature, that is to say between 100° C. and 250° C. In other words, the additive and the epoxidized oil are added simultaneously to the recycled bitumen.

According to a second embodiment, the epoxidized oil, the bitumen additive, and optionally the other additives present in the composition are added sequentially in any order to the recycled bituminous product at high temperature, that is to say between 100° C. and 250° C.

According to a third embodiment, the composition is prepared by mixing the epoxidized oil, the bitumen additive, fresh bitumen and optionally other additives present in the composition. The mixture is then added to the recycled bituminous product at high temperature, that is to say between 100° C. and 250° C. In other words, the epoxidized oil, the additive and the fresh bitumen are added simultaneously to the recycled bitumen.

According to a fourth embodiment, the epoxidized oil, the bitumen additive, the fresh bitumen and optionally the other additives present in the composition are added sequentially in any order to the recycled bituminous product at high temperature, that is to say between 100° C. and 250° C. The invention also relates to the use of the composition as defined above for preparing a mix having improved properties in terms of aging.

A subject of the invention is also a mix comprising the composition as defined above and mineral aggregates.

The invention also relates to a drivable surface made from the mix defined above. The drivable surface can be road coverings, sidewalks, aircraft runways, cycle paths, parking areas.

Examples of applications of the present invention include the production of mixes containing mineral aggregates, said mixes being used for earthworks and sealing, and more specifically in the construction, repair and maintenance of sidewalks, roads, highways, parking lots or airport runways and service roads, and any other driveable surface.

The invention lastly relates to a composition comprising:
at least one epoxidized oil as defined above, and
at least one bitumen additive as defined above.

Preferably, the composition according to the invention may comprise:
at least one epoxidized oil chosen from epoxidized fatty acid monoesters, epoxidized fatty acid diesters, epoxidized fatty acid triesters and a mixture thereof, preferably epoxidized fatty acid diesters, epoxidized fatty acid triesters and a mixture thereof, more particularly, epoxidized fatty acid triesters, and
at least one additive chosen from the compounds of formula (1) and the compounds of formula (2) below:

[A-O—B-]_{d}Z (1)

(E)ⱼ-Y (2)

wherein:
A is chosen from a hydrogen atom, B denotes a divalent group comprising repeating units of butylene oxide (BO), propylene oxide (PO) and/or ethylene oxide (EO) type, generally distributed randomly or in blocks, preferentially in blocks, d is equal to 1 and Z denotes a hydrogen atom, the group E represents a group G or a group

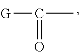

and preferably E represents a group G, where G represents a linear or branched, preferentially linear, saturated or partially unsaturated, preferentially partially unsaturated, C₁₄-C₂₂ hydrocarbon-based chain, j is equal to 1 and Y is a polyethyleneamine.

The composition according to the invention may comprise from 10% to 95% by weight of epoxidized oil relative to the total weight of the composition, preferably from 10% to 92% by weight, more particularly from 50% to 90% by weight, more particularly from 60% to 90% by weight.

The composition according to the invention may comprise from 5% to 90% by weight of bitumen additive relative to the total weight of the composition, preferably from 8% to 80% by weight, more particularly from 10% to 50% by weight, more particularly from 10% to 40% by weight.

The composition according to the invention preferably comprises the epoxidized oil and the bitumen additive in a weight ratio of between 10:1 and 1:1, preferably between 8:1 and 2:1.

Preferably, the composition does not comprise solvent. However, according to another embodiment, the composition according to the invention may be in a form diluted in a solvent. Thus, the composition can comprise water, organic solvents, inorganic solvents and a mixture thereof. The organic solvents can be chosen from alcohols, plant oils and mineral oils. Preferably, organic solvents are preferred. Depending on the solvent present in the composition, the latter may be in the form of an emulsion.

Preferably, the composition is in the form of an emulsion, comprising water and one or more emulsifiers, optionally one or more organic or mineral acids or organic or mineral bases.

The emulsifiers can be cationic or anionic or nonionic or amphoteric or zwitterionic surfactants.

The invention relates to the use of the composition as defined above as a bitumen additive, and in particular as an antiaging additive. In other words, the invention targets the use of said composition for slowing down bitumen aging, preferably bitumen consisting completely or partly of recycled bitumen.

The composition can be added to the bitumen in a content of between 0.01% and 10% by weight, preferably between 0.05% and 10% by weight, more particularly between 0.05% and 8% by weight, and even more preferentially between 0.05% and 5% by weight relative to the total weight of the bituminous product.

The invention is illustrated by the following examples, which are in no way limiting.

### Sample Preparation

The following samples were prepared according to table 1 below. The contents are expressed as weight percentages.

TABLE 1

| | 1 | 2 | 3 |
|---|---|---|---|
| Example | comparative | invention | invention |
| Fresh bitumen | 50 | 48.5 | 48.5 |
| Recycled bitumen | 50 | 48.5 | 48.5 |
| Epoxidized oil | — | 2.4 | 2.4 |
| (Vikoflex ® 7170) | | | |
| Additive | — | 0.6 | — |
| (Ensoline ® PGE3600) | | | |
| Additive | — | — | 0.6 |
| (Polyram ® L920) | | | |

### Aging Tests

The fresh bitumen is 160/200 bitumen sold by Total and originating from the Feyzin plant. The recycled bitumen is a 10-20 penetrability bitumen. The epoxidized oil is Vikoflex® 7170 oil sold by Arkema France.

The bitumen additives are an Ensoline® PEG 3600 copolymer sold by Arkema France and a Polyram® L920 amidoamine-type additive sold by Arkema France.

The fresh bitumen, the epoxidized oil and the bitumen additive are mixed at room temperature, then are heated for 30 min at 150° C. Next, the mixture is added to the recycled bitumen. The mixture is stirred for 3 min at 400 rpm with a Rayneri-type mixer. This mixture is left to cool to room temperature.

A thin layer film of 200 μm is produced on a metal plate. Two samples are made for each bituminous composition. The first series of samples will be used to measure unaged G*/sin(δ). The second series of samples will be aged, then the aged G*/sin(δ) will be measured.

The first series of measurements is carried out on the prepared samples. The thin layer film is placed on the lower plate of the plate/plate equipment of the rheometer. After adjustment of the gap, the rheology measurements are carried out. This first measurement carried out on the film, before aging, is noted as “unaged”.

A second series of samples is placed for thermal aging in a ventilated oven at a temperature of 150° C. for 2 hours.

After aging, the films are left at ambient temperature for cooling. Each sample is then placed on the lower plate of the plate/plate equipment of the rheometer. After adjustment of the gap, the rheology measurements are carried out in order to obtain the aging index I, as calculated according to the formula defined in the paragraph above. The results obtained are collated in table 2 below:

TABLE 2

| | Example 1 | Example 2 | Example 3 |
|---|---|---|---|
| Aging index I | 7.9 | 4.9 | 4.7 |

The results show that the presence of the mixture of epoxidized oil and additive in the bitumen makes it possible to slow down the aging of the latter. According to the values obtained, a slowdown of the aging of the order of 40% is observed compared to the mixture of bitumens alone. This result is obtained with a proportion of recycled bitumen of 50%.

In other words, the presence of additives makes it possible to almost double the service life of the bituminous coating, half the composition of which consists of a recycled bitumen.

1. A bituminous composition comprising:
at least one recycled bituminous product,
at least one epoxidized oil, and
at least one bitumen additive.

2. The bituminous composition as claimed in claim 1, comprising an epoxidized oil chosen from epoxidized fatty acid monoesters, epoxidized fatty acid diesters, epoxidized fatty acid triesters and a mixture thereof.

3. The bituminous composition as claimed in claim 1, wherein the epoxidized oil is obtained from avocado oil, coconut oil, castor oil, corn oil, cottonseed oil, linseed oil, grapeseed oil, hemp oil, jojoba oil, mustard oil, dehydrated castor oil, palm oil, rapeseed oil, safflower oil, soybean oil, sunflower oil, tall oil, olive oil, linoleic oil, peanut oil or mixtures thereof.

4. The bituminous composition as claimed in claim 1, wherein the at least one bitumen additive is chosen from formula (1) and the compounds of formula (2) below:
[A-O—B-]_{d}Z (1)
(E)ⱼ-Y (2)
wherein:
A is chosen from a hydrogen atom, a group G, a group 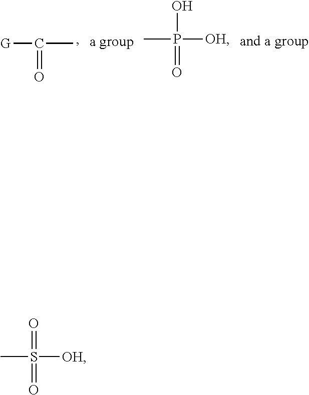
where G represents a linear or branched, saturated or unsaturated C₁-C₃₀ hydrocarbon-based chain optionally comprising at least one aromatic ring, and optionally substituted with at least one phosphate group, preferentially a single phosphate group,
B represents a divalent group containing at least one repeating unit of alkylene oxide type,
d is equal to 1 or to 2, and
Z is chosen from a hydrogen atom, a radical of formula Z1 and a radical of formula Z2: 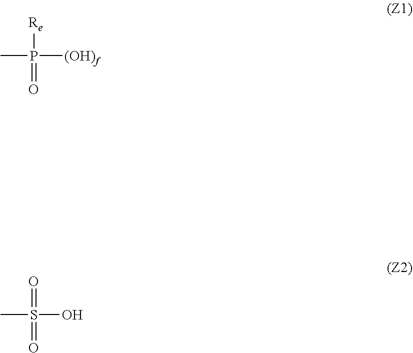
where R represents a hydrogen atom or a linear or branched C₁-C₆ alkyl group, f is equal to 0, 1 or 2, e is equal to 0 or to 1, and d+e+f is equal to 3,
a group G, and a group 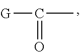
where G is as defined above,
it being understood that when d is equal to 1, then Z is chosen from a hydrogen atom, a radical of formula Z1, a radical of formula Z2, a group G, and a group 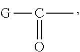
where G is as defined above,
and that when d is equal to 2, then Z represents Z1, e is equal to zero (0) and P is bonded to two groups [A-O—B-] which may be identical or different, preferentially identical, as defined above,
E is chosen from the groups G, 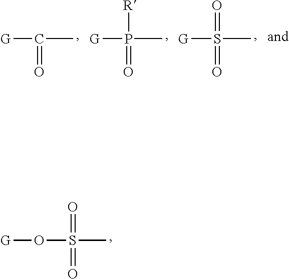
where G is as defined above,
j is equal to 1 or 2,
R′ is chosen from the group consisting of HO—, Q-O— and Q, where Q represents a linear or branched C₁-C₆ alkyl radical,
Y represents a group chosen from —O-T, —S-T, —N(H)₍₂₋ⱼ₎-T and -NT₁T₂, and preferentially Y represents —N(H)₍₂₋ⱼ₎-T or -NT₁T₂, provided that Y does not represent —S-T, when E is bonded to Y via a sulfur atom,
T represents a hydrogen atom or a group which is linear, branched or cyclic or contains a cyclic group and which comprises carbon and hydrogen atoms, and optionally one or more heteroatoms chosen from nitrogen, oxygen, sulfur and phosphorus, and
the radicals T₁ and T₂ are identical or different and have the same value as T defined above, or form together and with the nitrogen atom to which they are bonded a saturated, partially saturated or unsaturated heterocycle optionally also comprising one or more heteroatoms chosen from nitrogen, oxygen, sulfur and phosphorus.

5. The bituminous composition as claimed in claim 1, wherein the bitumen additive is of formula (1), wherein A denotes a hydrogen atom, B denotes a divalent group comprising repeating units of butylene oxide (BO), propylene oxide (PO) and/or ethylene oxide (EO) type, d is equal to 1 and Z denotes a hydrogen atom.

6. The bituminous composition as claimed in claim 1, wherein the bitumen additive is of formula (2), wherein the group E represents a group G or a group 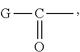
where G represents a linear or branched, saturated or partially unsaturated, C₁₄-C₂₂ hydrocarbon-based chain, j is equal to 1 and Y is a polyethyleneamine.

7. The bituminous composition as claimed in claim 1, wherein the composition comprises a bitumen additive content of between 0.01% and 10% by weight, relative to the total weight of the composition.

8. The bituminous composition as claimed in claim 1, wherein the composition comprises an epoxidized oil content of between 0.01% and 10% by weight, relative to the total weight of the composition.

9. The bituminous composition as claimed in claim 1, wherein the composition comprises non-recycled bitumen.

10. The bituminous composition as claimed in claim 1, wherein the composition is in the form of an emulsion.

11. The bituminous composition as claimed in claim 1, wherein the bitumen comprises from 10% to 90% by weight of recycled bitumen, relative to the total weight of the composition.

12. A method for preparing a mix having improved properties in terms of aging, comprising adding an effective amount of the bituminous composition as defined in claim 1 as a component of the mix.

13. A mix comprising the composition as defined in claim 1 and mineral aggregates.

14. A composition comprising:
at least one epoxidized oil and at least one bitumen additive as defined in claim 1.

15. The composition as claimed in claim 14, wherein the composition is in the form of an emulsion.

16. A composition comprising the composition as defined in claim 14 as a bitumen additive.
